(19) United States
(12) Patent Application Publication
(10) Pub. No.: US 2011/0016485 A1
(43) Pub. Date: Jan. 20, 2011

(54) DOUBLE-CLICK CHANNEL BUTTON ACCESS OF USER-DEFINED CONTENT LIST

(75) Inventors: Paul V. HUBNER, McKinney, TX (US); Kristopher A. PATE, Sachse, TX (US); Steven T. ARCHER, Dallas, TX (US); Robert A. CLAVENNA, Lucas, TX (US)

Correspondence Address: VERIZON;PATENT MANAGEMENT GROUP, 1320 North Court House Road, 9th Floor, ARLINGTON, VA, 22201-2909, US

(73) Assignee: VERIZON PATENT AND LICENSING, INC., Basking Ridge, NJ (US)

(21) Appl. No.: 12/502,656

(22) Filed: Jul. 14, 2009

(51) Int. Cl. H04N 7/16; H04N 5/44; H04N 5/445

(52) U.S. Cl. 725/30; 348/734; 725/56; 725/38; 725/131; 348/E05.096

(57) ABSTRACT

A set-top box receives a channel input from a remote control associated with a user, and determines whether the channel input is a double-click channel input. The set-top box retrieves a user-defined content list, associated with the user, when the channel input is determined to be a double-click channel input, and tunes to a channel associated with the retrieved user-defined content list. The set-top box also receives content associated with the tuned to channel, and provides the received content to a television, where the television displays the received content to the user.

### BACKGROUND

Many television users (or viewers) regularly watch a limited number of television (TV) channels. Some television systems permit users to create a favorites (or preferred) list of television channels. For example, a favorite channels list is a list of television channels that a user watches the most. Instead of scrolling through an entire channel list to find the user's most-watched channels, the user can create a list of favorite television channels and access the favorite channels list via a remote control.

To select a particular channel from a favorite channels list, the user (e.g., via a remote control) typically must access the favorite channels list, navigate the favorite channels list to locate the particular channel, and select the particular channel when it is located. Such a selection process is cumbersome because it requires visual searching by the user, user concentration, and onscreen navigation by the user.

### BRIEF DESCRIPTION OF THE DRAWINGS

FIG. 1 depicts a diagram of an exemplary network in which systems and/or methods described herein may be implemented;

FIG. 2 illustrates exemplary components of a set-top box (STB) and/or a content server of the network depicted in FIG. 1;

FIG. 3 depicts exemplary components of a remote control of the network illustrated in FIG. 1;

FIGS. 4A-4C illustrate diagrams of exemplary user interfaces capable of being generated or provided by a television, the STB, and/or the content server of the network depicted in FIG. 1;

FIGS. 5A-5C depict diagrams of exemplary interactions between components of an exemplary portion of the network illustrated in FIG. 1;

FIG. 6 illustrates a diagram of exemplary functional components of the STB of the network depicted in FIG. 1;

FIG. 7 depicts a diagram of a portion of an exemplary database capable of being provided in and/or managed by the STB and/or the content server of the network illustrated in FIG. 1; and

FIGS. 8-10 illustrate flow charts of an exemplary process for selecting user-defined content using a double-click channel input according to implementations described herein.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Systems and/or methods described herein may permit a user to select a channel of from a user-defined content list (e.g., a favorite television channels list) based on a double-click channel input provided by a user via a remote control. In one implementation, for example, the systems and/or methods may receive a channel input from a remote control associated with a user, and may determine whether the channel input is a “double-click” channel input. The systems and/or methods may retrieve a user-defined content list (e.g., a favorite television channels list) when the channel input is determined to be a double-click, and may tune to a channel of the retrieved user-defined content list. The systems and/or methods may receive content associated with the tuned to channel, and may provide the received content for display to the user. Such an arrangement may reduce an amount of interaction required to navigate through a user-defined content list by reducing the number of remote control button selections to one, by reducing the number of sensory perceptions to one, and by removing the need for navigation and selection.

As user herein, the term “double-click” is intended to be broadly interpreted to include an act of pressing a device (e.g., a remote control, a computer mouse button, etc.), or a component (e.g., a button) of the device, twice quickly (e.g., within a predetermined amount of time); an act allows two different actions to be associated with the same device button; etc.

As used herein, the terms “customer,” “viewer,” and/or “user” may be used interchangeably. Also, the terms “customer,” “viewer,” and/or “user” are intended to be broadly interpreted to include a STB, a remote control, and/or a television or a user of a STB, remote control, and/or television.

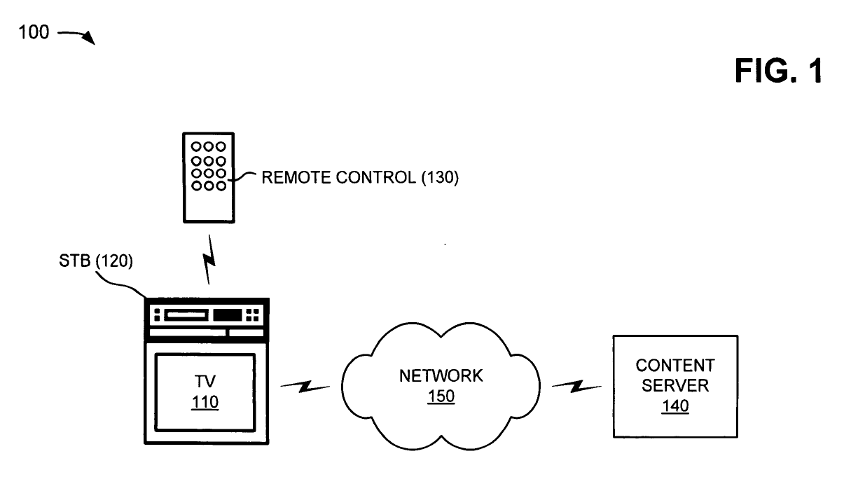

FIG. 1 is a diagram of an exemplary network 100 in which systems and/or methods described herein may be implemented. As illustrated, network 100 may include a television (TV) 110, a STB 120, a remote control 130, and a content server 140 interconnected by a network 150. Components of network 100 may interconnect via wired and/or wireless connections. A single television 110, STB 120, remote control 130, content server 140, and network 150 have been illustrated in FIG. 1 for simplicity. In practice, there may be more televisions 110, STBs 120, remote controls 130, content servers 140, and/or networks 150.

Television 110 may include a television monitor that is capable of displaying television programming, content provided by STB 120, and/or content provided by other devices (e.g., a digital video disk (DVD) player, a video camera, etc., not shown) connected to television 110.

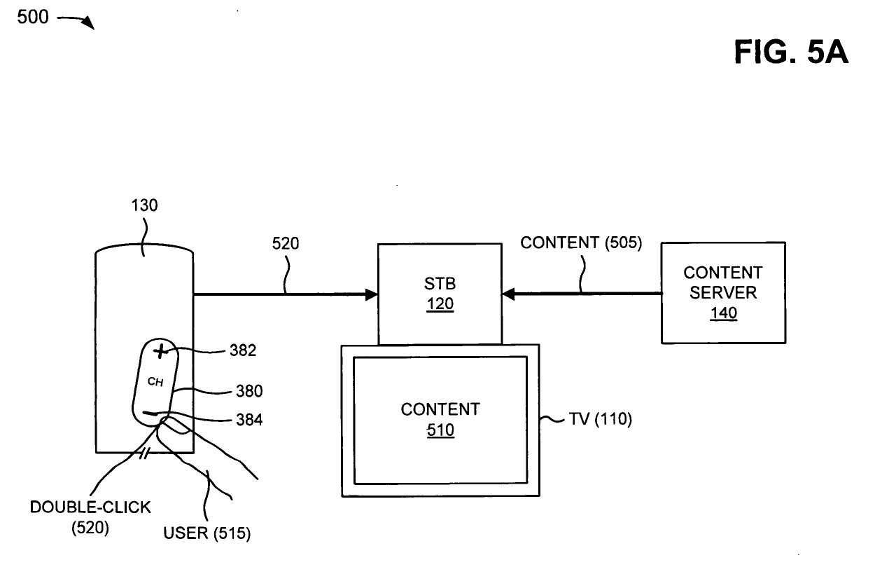

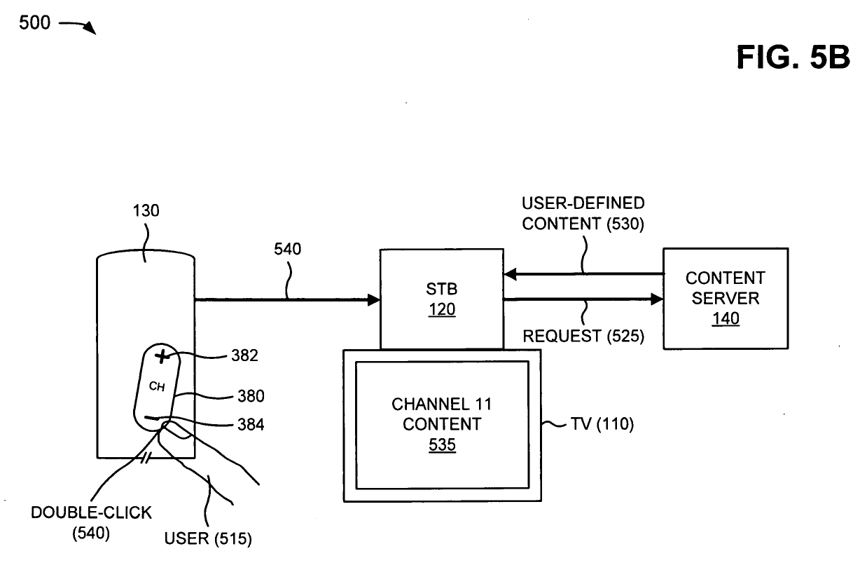

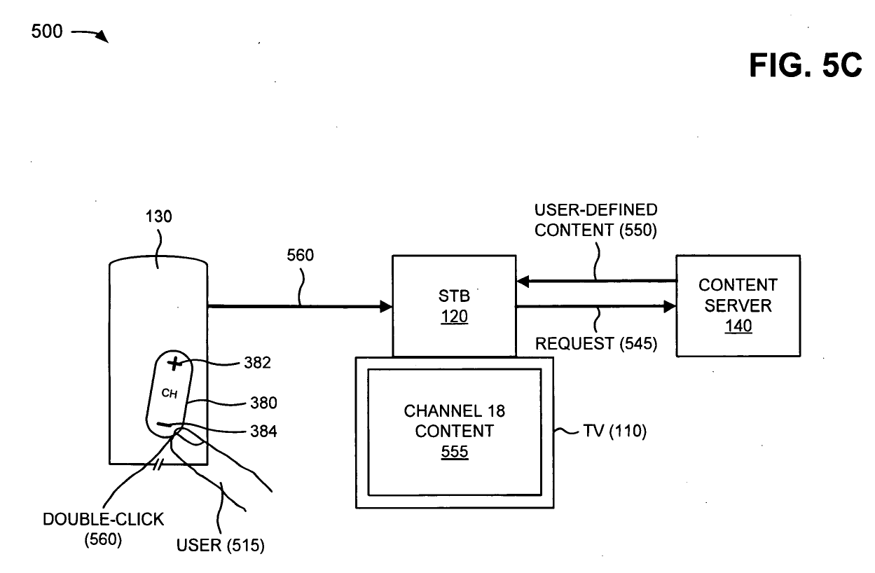

STB 120 may include a device that receives television programming (e.g., from content server 140), and provides the television programming to television 110 or another device. STB 120 may allow a user to alter the television programming provided to television 110 based on a signal (e.g., a channel up or channel down signal) from remote control 130. STB 120 may record video in a digital format to a disk drive or other memory medium within STB 120. In one exemplary implementation, STB 120 may be incorporated directly within television 110 and/or may include a digital video recorder (DVR). Further details of STB 120 are provided below in connection with, for example, FIGS. 5A-7.

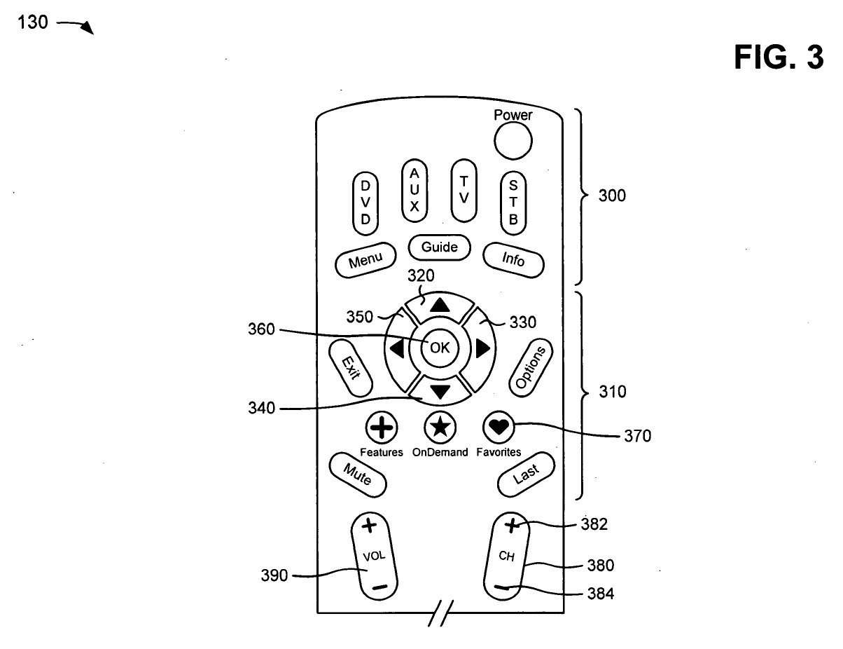

Remote control 130 may include a device that allows a user to control television programming and/or content displayed on television 110 via interaction with television 110 and/or STB 120. For example, remote control 130 may alter television programming provided to television 110 via user selection of a channel up or channel down button of remote control 130. Further details of remote control 130 are provided below in connection with, for example, FIGS. 3-5C.

Content server 140 may include one or more server entities, or other types of computation or communication devices, that gather, process, search, and/or provide information in a manner described herein. In one implementation, content server 140 may include a computer system, an application, a cable head-end, and/or a broadcasting device capable of providing content (e.g., video-on-demand (VOD) content, high definition (HD)-VOD content, TV programming, movies, on-demand services, live television, etc.), advertisements, instructions, and/or other information to STB 120.

Network 150 may include a local area network (LAN), a wide area network (WAN), a metropolitan area network (MAN), a telephone network, such as the Public Switched Telephone Network (PSTN), an intranet, the Internet, an optical fiber (or fiber optic)-based network, a cable television network, a satellite television network, or a combination of networks.

Although FIG. 1 shows exemplary components of network 100, in other implementations, network 100 may contain fewer, different, differently arranged, and/or additional components than those depicted in FIG. 1. In still other implementations, one or more components of network 100 may perform one or more other tasks described as being performed by one or more other components of network 100.

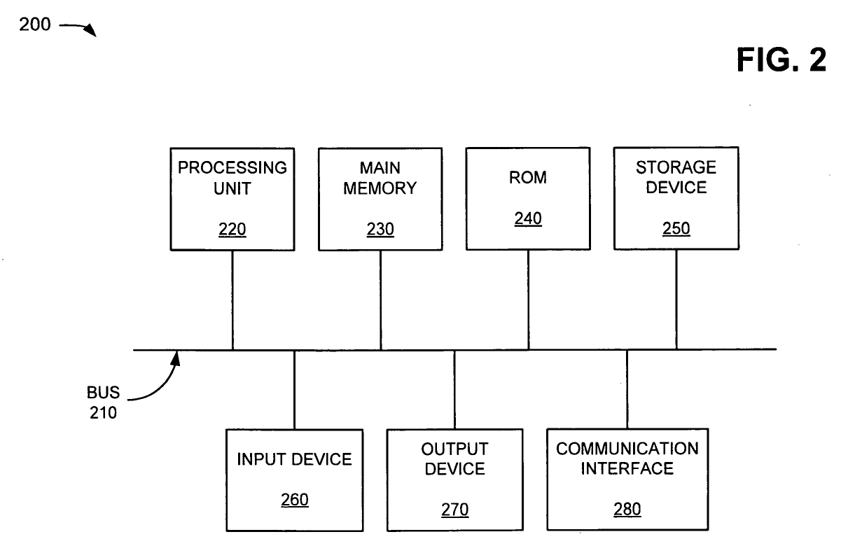

FIG. 2 is an exemplary diagram of a device 200 that may correspond to STB 120 and/or content server 140. As illustrated, device 200 may include a bus 210, a processing unit 220, a main memory 230, a read-only memory (ROM) 240, a storage device 250, an input device 260, an output device 270, and/or a communication interface 280. Bus 210 may include a path that permits communication among the components of device 200.

Processing unit 220 may include one or more processors, microprocessors, or other types of processing units that may interpret and execute instructions. Main memory 230 may include one or more random access memories (RAMs) or other types of dynamic storage devices that may store information and instructions for execution by processing unit 220. ROM 240 may include one or more ROM devices or other types of static storage devices that may store static information and/or instructions for use by processing unit 220. Storage device 250 may include a magnetic and/or optical recording medium and its corresponding drive.

Input device 260 may include a mechanism that permits a user to input information to device 200, such as a keyboard, a mouse, a pen, a microphone, voice recognition and/or biometric mechanisms, a remote control, a touch screen, etc. Output device 270 may include a mechanism that outputs information to the user, including a display, a printer, a speaker, etc. Communication interface 280 may include any transceiver-like mechanism that enables device 200 to communicate with other devices, networks, and/or systems. For example, communication interface 280 may include mechanisms for communicating with another device or system via a network.

As described herein, device 200 may perform certain operations in response to processing unit 220 executing software instructions contained in a computer-readable medium, such as main memory 230. A computer-readable medium may be defined as a physical or logical memory device. A logical memory device may include memory space within a single physical memory device or spread across multiple physical memory devices. The software instructions may be read into main memory 230 from another computer-readable medium, such as storage device 250, or from another device via communication interface 280. The software instructions contained in main memory 230 may cause processing unit 220 to perform processes described herein. Alternatively, hardwired circuitry may be used in place of or in combination with software instructions to implement processes described herein. Thus, implementations described herein are not limited to any specific combination of hardware circuitry and software.

Although FIG. 2 shows exemplary components of device 200, in other implementations, device 200 may contain fewer, different, differently arranged, and/or additional components than depicted in FIG. 2. In still other implementations, one or more components of device 200 may perform one or more other tasks described as being performed by one or more other components of device 200.

FIG. 3 depicts exemplary components of remote control 130. As shown, remote control 130 may include a first set 300 of control buttons and a second set 310 of control buttons. Although FIG. 3 shows control buttons associated with remote control 130, in other implementations, remote control 130 may include a touch screen display (or other input mechanisms) and may omit the control buttons. The touch screen display may be configured to display images of control buttons (e.g., similar to the control buttons provided in FIG. 3) and to receive a user input when the user touches the touch screen display. For example, the user may provide an input to the touch screen display directly, such as via the user's finger, or via other input objects, such as a stylus. User inputs received via the touch screen display may be processed by components and/or devices operating in remote control 130. The touch screen display may permit the user to interact with remote control 130 in order to cause remote control 130 to perform one or more operations.

First set 300 of control buttons may include one or more control buttons that cause remote control 130 to perform one or more operations. For example, first set 300 of control buttons may cause remote control 130 to transmit one or more signals (e.g., to STB 120) representative of the one or more operations. As shown in FIG. 3, first set 300 of control buttons may include a power button (e.g., to cause, when selected by a user, remote control 130 to transmit a signal instructing a device (e.g., STB 120) to power on or power off); a digital video recorder (DVD) button (e.g., to cause, when selected by a user, remote control 130 to transmit a signal instructing a DVD player (not shown) to perform an operation); an auxiliary (AUX) button (e.g., to cause, when selected by a user, remote control 130 to transmit a signal instructing an auxiliary device (e.g., a stereo) to perform an operation); a TV button (e.g., to cause, when selected by a user, remote control 130 to transmit a signal instructing television 110 to perform an operation); and a STB button (e.g., to cause, when selected by a user, remote control 130 to transmit a signal instructing STB 120 to perform an operation).

As further shown in FIG. 3, first set 300 of control buttons may include a menu button, a guide button, and an information (Info) button. The menu button, when selected by a user, may cause remote control 130 to transmit a signal instructing STB 120 to display (e.g., on television 110) a television menu (e.g., a menu that provides access to features associated with a television service). The guide button, when selected by a user, may cause remote control 130 to transmit a signal instructing STB 120 to display (e.g., on television 110) a television guide (e.g., an interactive programming guide, a listing of all available television channels, etc.). The information button, when selected by a user, may cause remote control 130 to transmit a signal instructing STB 120 to display (e.g., on television 110) information about a currently displayed television program.

Second set 310 of control buttons may include one or more control buttons that cause remote control 130 to perform one or more operations. For example, second set 310 of control buttons may cause remote control 130 to transmit one or more signals (e.g., to STB 120) representative of the one or more operations. As shown in FIG. 3, second set 310 of control buttons may include an exit button (e.g., to cause, when selected by a user, remote control 130 to transmit a signal instructing STB 120 to resume a television program currently being watched); an options button (e.g., to cause, when selected by a user, remote control 130 to transmit a signal instructing STB 120 to display extra options or a help menu); a features button (e.g., to cause, when selected by a user, remote control 130 to transmit a signal instructing STB 120 to access local traffic, weather, and other information); and an OnDemand button (e.g., to cause, when selected by a user, remote control 130 to transmit a signal instructing STB 120 to access VOD, HD-VOD, on-demand services, etc.).

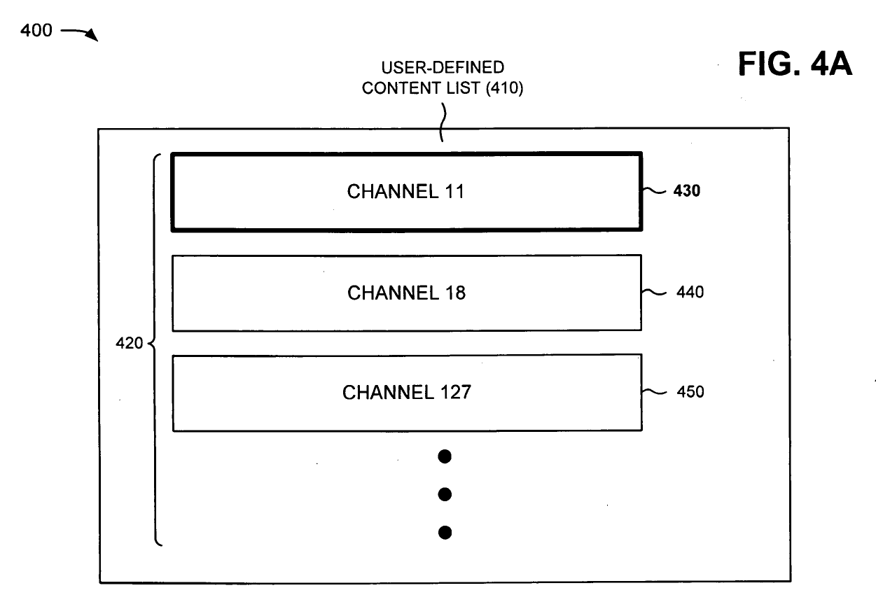

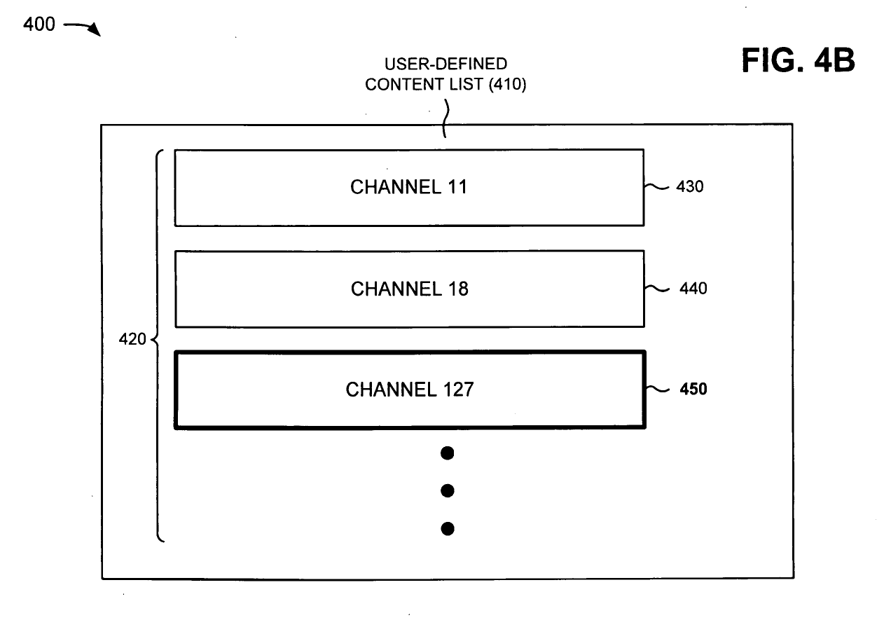

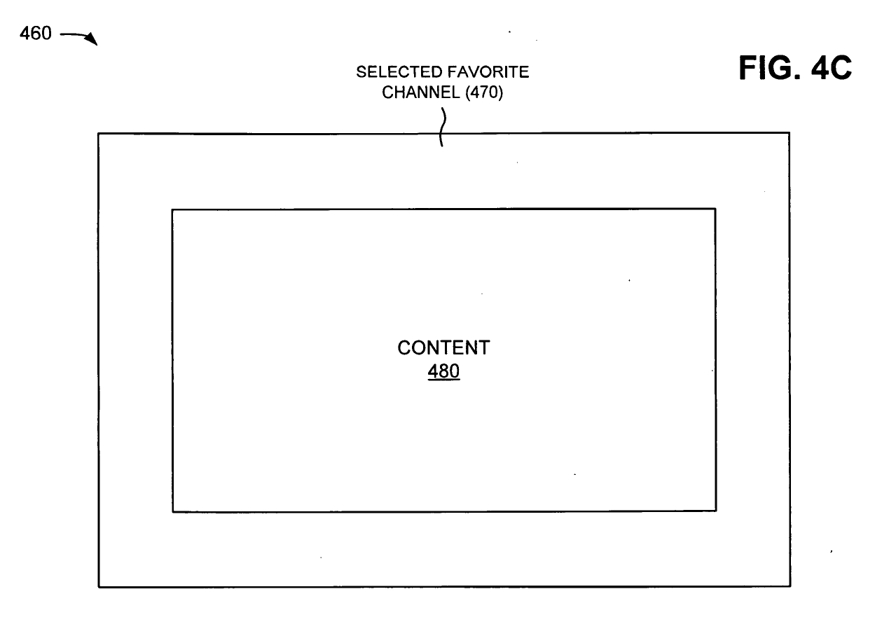

As further shown in FIG. 3, second set 310 of control buttons may include an up arrow button 320, a right arrow button 330, a down arrow button 340, a left arrow button 350, an OK button 360, a favorites button 370. Arrow buttons 320-350 may permit a user (e.g., via remote control 130) to navigate through a menu displayed by STB 120 (e.g., via television 110). OK button 360 may permit a user (e.g., via remote control 130) to select an item of a menu displayed by STB 120 (e.g., via television 110). Favorites button 370, when selected by a user, may cause remote control 130 to transmit a signal instructing STB 120 to access a user-defined content list (e.g., a favorite television channels list, a preferred television channels list, a list of VOD, a list of HD-VOD, a list of user-defined television channels, etc.) and display the user-defined content list on television 110. An example of accessing and navigating a user-defined content list (e.g., via arrow buttons 320-350, OK button 360, and favorites button 370) is provided below in connection with the user interfaces depicted in FIGS. 4A-4C.

Remote control 130 may also include a channel button 380 (e.g., with an up channel portion 382 and a down channel portion 384) and a volume button 390. Channel button 380, when selected by a user, may cause remote control 130 to transmit a signal instructing STB 120 to select a next higher or lower channel for display on television 110. For example, if a user selects up channel portion 382 of channel button 380, remote control 130 may transmit a signal instructing STB 120 to select a next higher channel for display on television 110. In another example, if the user selects down channel portion 384 of channel button 380, remote control 130 may transmit a signal instructing STB 120 to select a next lower channel for display on television 110. Volume button 390, when selected by a user, may cause remote control 130 to transmit a signal instructing STB 120 to increase or decrease a volume associated with content being displayed on television 110.

Although FIG. 3 shows exemplary components of remote control 130, in other implementations, remote control 130 may contain fewer, different, differently arranged, and/or additional components than depicted in FIG. 3. In still other implementations, one or more components of remote control 130 may perform one or more other tasks described as being performed by one or more other components of remote control 130.

FIGS. 4A-4C illustrate diagrams of exemplary user interfaces capable of being generated or provided by television 110, STB 120, and/or content server 140. Each of the user interfaces depicted in FIGS. 4A-4C may include a graphical user interface (GUI) or a non-graphical user interface, such as a text-based interface. The user interfaces may provide information to users via a customized interface (e.g., a proprietary interface) and/or other types of interfaces (e.g., a browser-based interface, a television interface, etc.). The user interfaces may receive user inputs via one or more input devices (e.g., remote control 130, input device 260, etc.), may be user-configurable (e.g., a user may change the size of the user interfaces, information displayed in the user interfaces, color schemes used by the user interfaces, positions of text, images, icons, windows, etc., in the user interfaces, etc.), and/or may not be user-configurable. The user interfaces may be displayed to a user via one or more output devices (e.g., television 110, output device 270, etc.).

As illustrated in FIGS. 4A and 4B, a user interface 400 may include a user-defined content list 410 that includes a list 420 of one or more favorite television channels (e.g., a first favorite channel 430, a second favorite channel 440, a third favorite channel 450, etc.). Information associated with user interface 400 may be selected by a user of STB 120 (e.g., via remote control 130). Referring to FIG. 3, a user may access user-defined content list 410 by selecting favorites button 370 on remote control 130. Remote control 130, in turn, may transmit a signal instructing STB 120 to display (e.g., on television 110) user-defined content list 410.

User-defined content list 410 may include information provided by STB 120 (e.g., via content server 140) and displayed on television 110. For example, user-defined content list 410 may include a favorite television channels list, a preferred television channels list, a list of VOD, a list of HD-VOD, a list of user-defined television channels, a program guide, a video-on-demand menu (e.g., that includes titles, categories, packages, etc.), information associated with the program guide and/or video-on-demand menu (e.g., preview, purchase, costs, etc.), advertisements, etc. In one implementation, user-defined content list 410 may include a list of television programming (e.g., television channels) that is defined by a user of STB 120. For example, the user may select (e.g., via STB 120 and remote control 130) various television channels and may add them to user-defined content list 410. User-defined content list 410 may be stored in STB 120 and/or content server 140.

List 420 may include a list of user-defined content, such as a list of favorite television channels. As shown in FIG. 4A, list 420 may include “CHANNEL 11” as first favorite channel 430, “CHANNEL 18” as second favorite channel 440, and “CHANNEL 127” as third favorite channel 450. A user may navigate through list 420 using arrow buttons 320-350 (FIG. 3) of remote control 130. When a user navigates to a particular favorite channel of list 420, the particular favorite channel may be highlighted (e.g., first favorite channel 430 may be highlighted in FIG. 4A). If the user wishes to navigate to third favorite channel 450 of list 420, the user may use down arrow button 340 (FIG. 3) of remote control 130 until third favorite channel 450 is highlighted, as shown in FIG. 4B. If the user wishes to view third favorite channel 450, the user may select OK button 360 (FIG. 3) of remote control 130, and a user interface 460 may be displayed by television 110, as shown in FIG. 4C.

User interface 460 may include a selected favorite channel 470 and content 480 associated with selected favorite channel 470. Selected favorite channel 470 may include a channel selected from list 420 by a user. For example, selected favorite channel 470 may include third favorite channel 450. STB 120 may receive, from remote control 130, selection of third favorite channel 450, and may tune STB 120 to third favorite channel 450. If STB 120 is tuned to third favorite channel 450, STB 120 may receive content (e.g., content 480) associated with third favorite channel 450 from content server 140. Content 480 may include content associated with selected favorite channel 470, such as television programming, advertising, VOD, HD-VOD, etc.

Although user interfaces 400 and 460 depict a variety of information, in other implementations, user interfaces 400 and 460 may depict less, different, differently arranged, and/or additional information than depicted in FIGS. 4A-4C.

FIGS. 5A-5C depict diagrams of exemplary interactions between components of an exemplary portion 500 of network 100. As illustrated, exemplary network portion 500 may include television 110, STB 120, remote control 130, and content server 140. Television 110, STB 120, remote control 130, and content server 140 may include the features described above in connection with, for example, FIGS. 1-3.

As shown in FIG. 5A, content server 140 may provide content 505 to STB 120, and STB 120 may display content 505 on television 110 (e.g., as content 510). Content 505 may include television content (e.g., television programming, advertisements, commercials, VOD, HD-VOD, interactive programming guides, etc.) capable of being displayed by television 110. Content 510 may include content 505 as displayed on television 110. In one example, STB 120 may tune to particular television content (e.g., a particular television channel), content server 140 may provide the particular television channel (e.g., content 505) to STB 120, and STB 120 may cause television 110 to display the particular television content (e.g., as content 5 10).

In implementations described herein and as further shown in FIG. 5A, a user 515 (e.g., represented as a finger of a user) may be associated with remote control 130. It may be assumed for implementations described herein that user 515 has previously created a user-defined content list (e.g., user-defined content list 410 (FIG. 4)) that may be stored (e.g., in a database) in STB 120 and/or content server 140. If user 515 wishes to tune STB 120 and television 110 to a channel (or other content item) of the user-defined content list, user 515 may double-click 520 up channel portion 382 or down channel portion 384 of channel button 380 of remote control 130. Remote control 130 may provide double-click 520 (e.g., as a channel input signal) to STB 120, and STB 120 may receive double-click 520 (e.g., the channel input signal).

STB 120 may determine whether the channel input signal is a “double-click” channel input, and may retrieve a user-defined content list (e.g., user-defined content list 410 (FIG. 4)) when STB 120 determines that the channel input signal is a double-click channel input. STB 120 may tune to a channel (e.g., to first favorite channel 430) of the retrieved user-defined content list, and may issue a request 525, to content server 140, for content associated with the tuned to channel, as shown in FIG. 5B. Request 525 may include a signal instructing content server 140 to provide content associated with the tuned to channel. Content server 140 may receive request 525, and may provide user-defined content 530, associated with the tuned to channel, to STB 120. User-defined content 530 may include television programming, advertisements, commercials, etc. associated with the tuned to channel. In one example, user-defined content 530 may include content associated with first favorite channel 430 of user-defined content list 410 (FIG. 4). STB 120 may receive user-defined content 530 associated with the tuned to channel, and may provide the received user-defined content 530 for display on television 110 (e.g., as content 535). In one example, content 535 may include content associated with “CHANNEL 11” (e.g., with first favorite channel 430).

As further shown in FIG. 5B, if user 515 wishes to tune STB 120 and television 110 to another channel (or other content item) of the user-defined content list, user 515 may double-click 540 up channel portion 382 (or down channel portion 384) of channel button 380 of remote control 130. In one exemplary implementation, user 515 may double-click up channel portion 382 to tune to a next channel of the user-defined content list, and may double-click down channel portion 384 to tune to a previous channel of the user-defined content list. In another exemplary implementation, user 515 may double-click up channel portion 382 to tune to a previous channel of the user-defined content list, and may double-click down channel portion 384 to tune to a next channel of the user-defined content list. Remote control 130 may provide double-click 540 (e.g., as a channel input signal) to STB 120, and STB 120 may receive double-click 540 (e.g., the channel input signal).

STB 120 may determine whether the channel input signal is a “double-click” channel input, and may retrieve a user-defined content list (e.g., user-defined content list 410 (FIG. 4)) when STB 120 determines that the channel input signal is a double-click channel input. STB 120 may tune to a channel (e.g., to second favorite channel 440) of the retrieved user-defined content list, and may issue a request 545, to content server 140, for content associated with the tuned to channel, as shown in FIG. 5C. Request 545 may include a signal instructing content server 140 to provide content associated with the tuned to channel. Content server 140 may receive request 545, and may provide user-defined content 550, associated with the tuned to channel, to STB 120. User-defined content 550 may include television programming, advertisements, commercials, etc. associated with the tuned to channel. In one example, user-defined content 550 may include content associated with second favorite channel 440 of user-defined content list 410 (FIG. 4). STB 120 may receive user-defined content 550 associated with the tuned to channel, and may provide the received user-defined content 530 for display on television 110 (e.g., as content 555). In one example, content 555 may include content associated with “CHANNEL 18” (e.g., with second favorite channel 440).

As further shown in FIG. 5C, if user 515 wishes to tune STB 120 and television 110 to another channel (or other content item) of the user-defined content list, user 515 may double-click 560 up channel portion 382 (or down channel portion 384) of channel button 380 of remote control 130. Remote control 130 may provide double-click 560 (e.g., as a channel input signal) to STB 120, and STB 120 may receive double-click 560 (e.g., the channel input signal). STB 120 may tune to a channel (e.g., to third favorite channel 450) of the retrieved user-defined content list as described above in connection with FIGS. 5A and 5B. Such an arrangement, as depicted in FIGS. 5A-5C, may reduce an amount of interaction required to navigate through a user-defined content list (e.g., a favorite channels list) by reducing the number of remote control 130 button selections to one, by reducing the number of sensory perceptions to one, and by removing the need for navigation and selection.

Although FIGS. 5A-5C depict an exemplary implementation of navigating a user-defined content list via a double-click of channel button 380 of remote control 130, in other implementations, one or more other buttons (or input mechanisms) of remote control 130 may be used (e.g., via the double-click) to navigate a user-defined content list. For example, volume button 390 of remote control 130 may implement the double-click functionality. In another example, one button (e.g., the information button (FIG. 3)) of remote control 130 may be double-clicked to tune to a next channel of the user-defined content list, and another button (e.g., the menu button (FIG. 3)) of remote control 130 may be double-clicked to tune to a previous channel of the user-defined content list. In still another example, a first button (e.g., up arrow button 320) of remote control 130 may be double-clicked to navigate a first user-defined content list (e.g., a favorite sports channels list), a second button (e.g., right arrow button 330) of remote control 130 may be double-clicked to navigate a second user-defined content list (e.g., a favorite news channels list), etc.

In an exemplary implementation, a user may utilize the double-click functionality to sequentially navigate between channels of a user-defined content list (e.g., a favorite channels list). For example, it may be assumed that the favorite channels list includes channels 3, 7, 11, and 15 and that the user is currently viewing channel 11. If the user single-clicks up channel portion 382 of channel button 380, channel 12 may be displayed to the user (e.g., via television 110). If the user then double-clicks up channel portion 382 of channel button 380, channel 15 may be displayed to the user (e.g., via television 110).

In another exemplary implementation, a time between clicks (e.g., of channel button 380) may be configurable in order to permit STB 120 to distinguish between channel surfing and double-clicking between channels on the favorite channels list. For example, STB 120 may receive (e.g., from remote control 130) a channel input (e.g., a first selection of channel button 380) at a first time, and may receive another channel input (e.g., a second selection of channel button 380) at a second time later than the first time. STB 120 may determine a time period between the first time and the second time, and may compare the determined time period to a user-defined time threshold. The user-defined time threshold may include a user-configurable time period (e.g., between zero seconds and one second) that enables STB 120 to distinguish between channel surfing and double-clicking between channels on a favorite channels list. STB 120 may determine the channel inputs to be a double-click when the determined time period is less than or equal to the user-defined time threshold.

In still another exemplary implementation, users (e.g., associated with remote control 130) may be associated with different user-defined content lists that utilize the double-click functionality described herein. For example, a first user may be associated with a favorite sports channels list and a second user may be associated with a favorite soap opera channels list. If the first user is identified with remote control 130 (e.g., via a password, a passcode, etc. provided to STB 120) and double-clicks channel button 380, STB 120 may navigate through the channels of the first user's favorite sports channels list. If the second user is identified with remote control 130 (e.g., via a password, a passcode, etc. provided to STB 120) and double-clicks channel button 380, STB 120 may navigate through the channels of the second user's favorite soap opera channels list.

In another exemplary implementation, a user may define different time periods of a day (e.g., morning, afternoon, and evening), and may define a different user-defined content list for each of the different time periods. For example, a particular user may prefer news channels in the morning, talk show channels in the afternoon, and drama channels in the evening. In such an arrangement, STB 120 may determine a particular user associated with remote control 130 (e.g., via a password, a passcode, etc. provided to STB 120 by remote control 130). STB 120 may retrieve (e.g., from a database associated with STB 120 and/or content server 140) user-defined content lists associated with the particular user, and may determine a time of day when a double-click channel input is received from remote control 130. STB 120 may select a time-based user-defined content list (e.g., a news channels list in the morning, a talk show channels list in the afternoon, and a drama channels list in the evening) from the retrieved user-defined content lists when the double-click channel input is received and based on the determined time of day. For example, if it is the afternoon when the double-click channel input is received, STB 120 may retrieve the news channels, talk show, and drama channels lists, may determine it is the afternoon, and may select the talk show channels list from the retrieved lists.

Although FIGS. 5A-5C show exemplary components of network portion 500, in other implementations, network portion 500 may contain fewer, different, differently arranged, and/or additional components than depicted in FIGS. 5A-5C. In still other implementations, one or more components of network portion 500 may perform one or more other tasks described as being performed by one or more other components of network portion 500. For example, in one implementation, some or all of the operations described as being performed by STB 120 may be performed by content server 140 alone or together with STB 120.

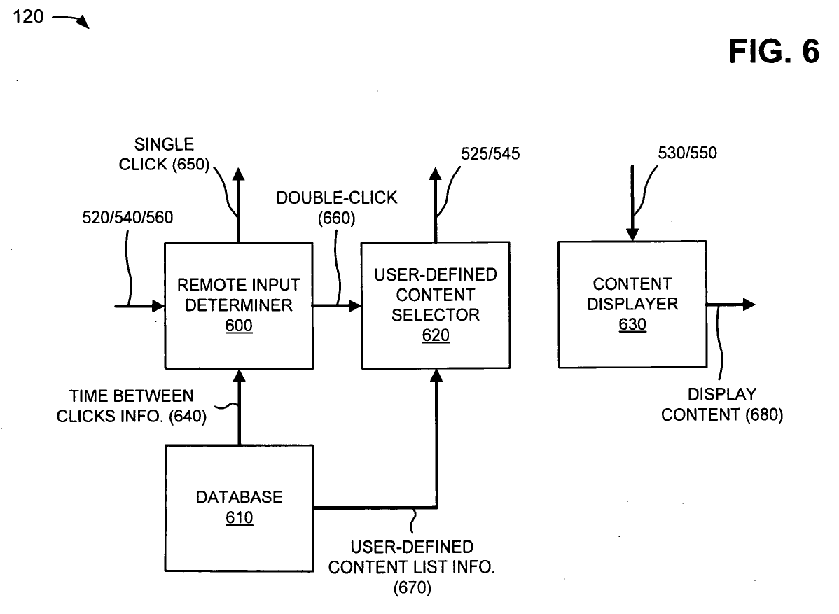

FIG. 6 illustrates a diagram of exemplary functional components of STB 120. In one implementation, the functions described in connection with FIG. 6 may be performed by one or more components of device 200 (FIG. 2). As shown in FIG. 6, STB 120 may include a remote input determiner 600, a database 610, a user-defined content selector 620, and a content displayer 630.

Remote input determiner 600 may include hardware or a combination of hardware and software that may receive double-click channel input 520, 540, and/or 560 from remote control 130 and may receive time between click information 640 from database 610. Time between click information 640 may include a user-configurable time period (e.g., between zero seconds and one second) that enables STB 120 to distinguish between channel surfing and double-clicking between channels on a favorite channels list. Remote input determiner 600 may determine whether double-click channel input 520/540/560 is a single click 650 or a double-click 660 based on time between click information 640. For example, remote input determiner 600 may determine double-click channel input 520/540/560 to be single click 650 when double-click channel input 520/540/560 is greater than the user-configurable time period, and may determine double-click channel input 520/540/560 to be double click 660 when double-click channel input 520/540/560 is less than or equal to the user-configurable time period. Remote input determiner 600 may provide double-click 660 to user-defined content selector 620.

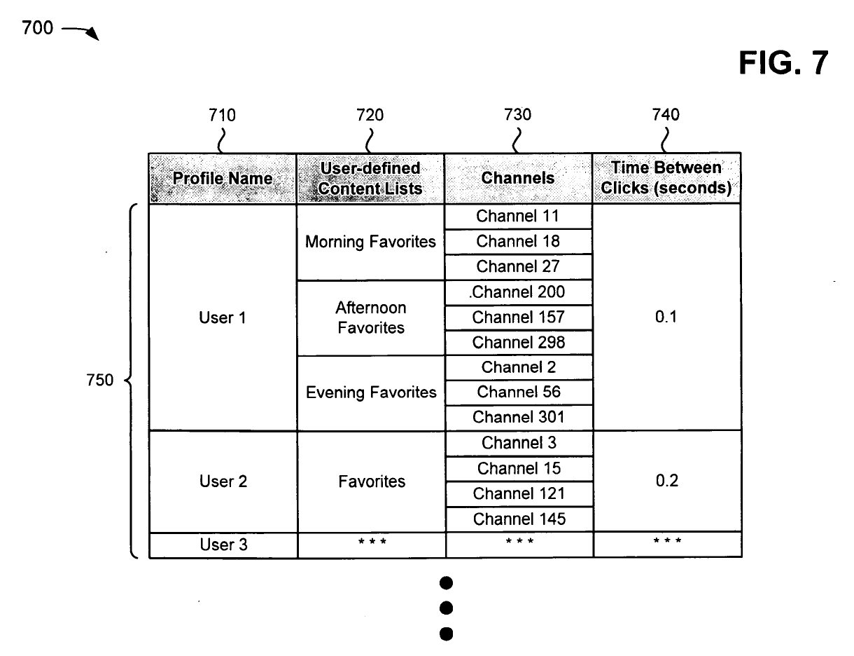

Database 610 may include a storage device (e.g., main memory 230, ROM 240, storage device 250, etc.) that may store information received by STB 120. In one implementation, database 610 may store information described below in connection with a database portion 700 (FIG. 7). For example, database 600 may store time between clicks information 640 and user-defined content list information 670. User-defined content list information 670 may include information associated with one or more user-defined content lists (e.g., a favorite television channels list, a preferred television channels list, a list of VOD, a list of HD-VOD, a list of user-defined television channels, etc.).

User-defined content selector 620 may include hardware or a combination of hardware and software that may receive double-click 660 from remote input determiner 600 and may receive user-defined content list information 670 from database 610. User-defined content selector 620 may generate requests 525 and/or 545 based on double-click 660 and user-defined content list information 670, and may provide requests 525/545 to content server 140.

Content displayer 630 may include hardware or a combination of hardware and software that may receive user-defined content 530 and/or 550 from content server 140, and may display content 680 (e.g., via television 110). Displayed content 680 may include one or more channels (or other content) associated with user-defined content 530/550.

Although FIG. 6 shows exemplary components of STB 120, in other implementations, STB 120 may contain fewer, different, differently arranged, and/or additional components than depicted in FIG. 6. In still other implementations, one or more components of STB 120 may perform one or more other tasks described as being performed by one or more other components of STB 120.

FIG. 7 depicts a diagram of a portion 700 of an exemplary database capable of being provided in and/or managed by STB 120 and/or content server 140. As illustrated, database portion 700 may include a variety of information associated with users, user-defined content lists, channels, and/or time between clicks information. For example, database portion 700 may include a profile name field 710, a user-defined content lists field 720, a channels field 730, a time between clicks field 740, and/or a variety of entries 750 associated with fields 710-740.

Profile name field 710 may include information associated with users (e.g., of television 110, STB 120, remote control 130, and/or content server 140), such as user identification, user name, user address, etc. For example, profile name field 710 may include entries for “User 1,” “User 2,” “User 3,” etc. In one example, each entry in profile name field 710 may include an identifier for a user (e.g., an account number, a password, etc.), the user's name, user contact information (e.g., address, telephone number, email address, etc.), etc.

User-defined content lists field 720 may include entries 750 providing information for user-defined content lists associated with the users provided in profile name field 710. For example, user-defined content lists field 720 may include entries 750 for time-based user-defined content lists (e.g., a morning favorites list, an afternoon favorites list, and an evening favorites list) associated with “User 1,” and a favorites list associated with “User 2.”

Channels field 730 may include entries 750 providing information for channels associated with the user-defined content lists provided in user-defined content lists field 720. For example, as shown in FIG. 7, the morning favorites list may include channels 11, 18, and 27; the afternoon favorites list may include channels 200, 157, and 298; the evening favorites list may include channels 2, 56, and 301; and the favorites list may include channels 3, 15, 121, and 145.

Time between clicks field 740 may include entries 750 providing information for user-defined time thresholds (e.g., a time between clicks of channel button 380) associated with the users provided in profile name field 710. For example, time between clicks field 740 may indicate that “User 1” has set the time between clicks to 0.1 seconds and that “User 2” has set the time between clicks to 0.2 seconds.

Although FIG. 7 shows exemplary information that may be provided in database portion 700, in other implementations, database portion 700 may contain less, different, differently arranged, and/or additional information than depicted in FIG. 7. For example, profile name field 710 may be omitted (e.g., in instances when there is a single user).

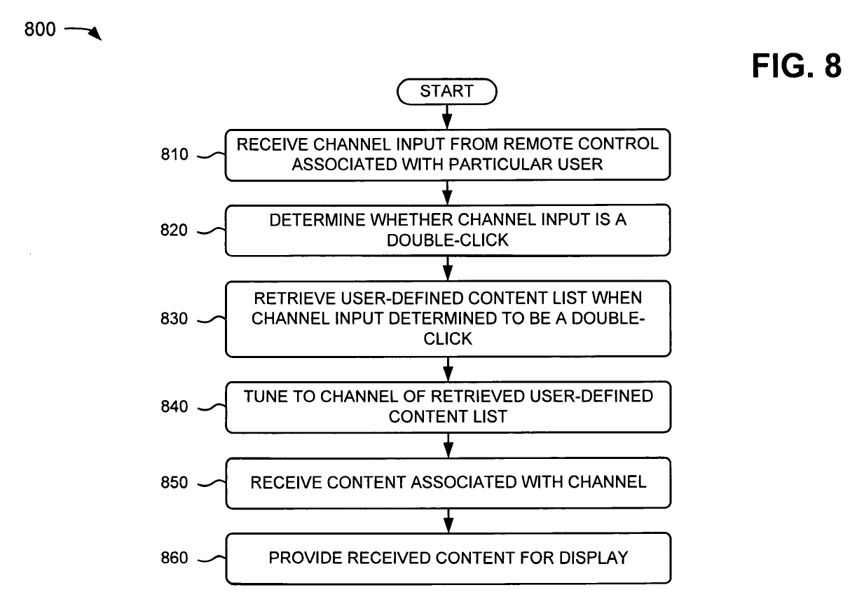

FIGS. 8-10 illustrate flow charts of an exemplary process 800 for selecting user-defined content using a double-click channel input according to implementations described herein. In one implementation, process 800 may be performed by STB 120. In another implementation, some or all of process 800 may be performed by another device or group of devices, including or excluding STB 120.

As illustrated in FIG. 8, process 800 may include receiving a channel input from a remote control associated with a particular user (block 810), and determining whether the channel input is a double-click (block 820). For example, in implementations described above in connection with FIG. 5A, if user 515 wishes to tune STB 120 and television 110 to a channel (or other content item) of the user-defined content list, user 515 may double-click 520 up channel portion 382 or down channel portion 384 of channel button 380 of remote control 130. Remote control 130 may provide double-click 520 (e.g., as a channel input signal) to STB 120, and STB 120 may receive double-click 520 (e.g., the channel input signal). STB 120 may determine whether the channel input signal is a “double-click” channel input.

As further shown in FIG. 8, a user-defined content list may be retrieved when the channel input is determined to be a double-click (block 830), and a channel of the retrieved user-defined content list may be tuned to (block 840). For example, in implementations described above in connection with FIG. 5B, STB 120 may retrieve a user-defined content list (e.g., user-defined content list 410 (FIG. 4)) when STB 120 determines that the channel input signal is a double-click channel input. STB 120 may tune to a channel (e.g., to first favorite channel 430) of the retrieved user-defined content list, and may issue a request 525, to content server 140, for content associated with the tuned to channel. Request 525 may include a signal instructing content server 140 to provide content associated with the tuned to channel.

Returning to FIG. 8, content associated with the tuned to channel may be received (block 850), and the received content may be provided for display (block 860). For example, in implementations described above in connection with FIG. 5B, content server 140 may receive request 525, and may provide user-defined content 530, associated with the tuned to channel, to STB 120. User-defined content 530 may include television programming, advertisements, commercials, etc. associated with the tuned to channel. In one example, user-defined content 530 may include content associated with first favorite channel 430 of user-defined content list 410 (FIG. 4). STB 120 may receive user-defined content 530 associated with the tuned to channel, and may provide the received user-defined content 530 for display on television 110 (e.g., as content 535). In one example, content 535 may include content associated with “CHANNEL 11” (e.g., with first favorite channel 430).

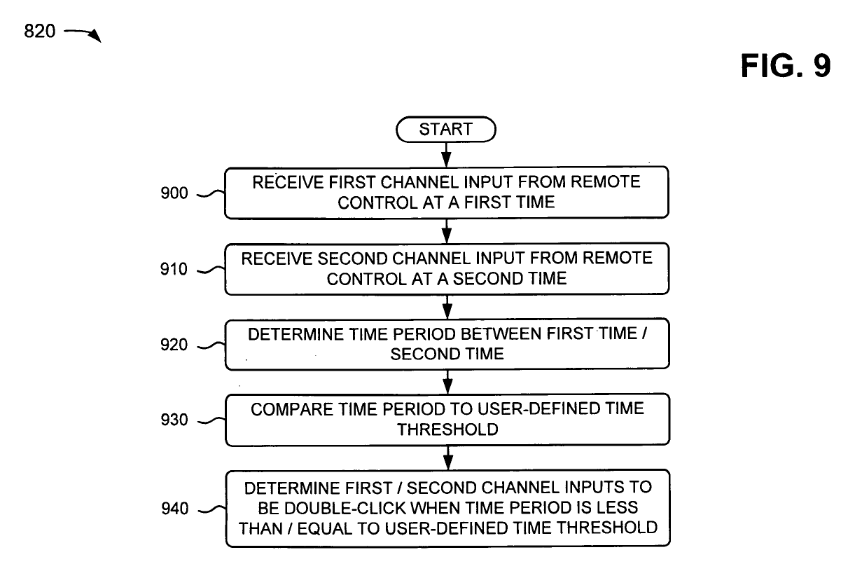

Process block 820 may include the process blocks depicted in FIG. 9. As shown in FIG. 9, process block 820 may include receiving a first channel input from the remote control at a first time (block 900), receiving a second channel input from the remote control at a second time (block 910), and determining a time period between the first time and the second time (block 920). For example, in implementations described above in connection with FIGS. 5A-5C, STB 120 may receive (e.g., from remote control 130) a channel input (e.g., a first selection of channel button 380) at a first time, and may receive another channel input (e.g., a second selection of channel button 380) at a second time later than the first time. STB 120 may determine a time period between the first time and the second time.

As further shown in FIG. 9, process block 820 may include comparing the determined time period to a user-defined time threshold (block 930), and determining the first and second channel inputs to be a double-click when the time period is less than and/or equal to the user-defined time threshold (block 940). For example, in implementations described above in connection with FIGS. 5A-5C, STB 120 may compare the determined time period to a user-defined time threshold. The user-defined time threshold may include a user-configurable time period (e.g., between zero seconds and one second) that enables STB 120 to distinguish between channel surfing and double-clicking between channels on a favorite channels list. STB 120 may determine the channel inputs to be a double-click when the determined time period is less than or equal to the user-defined time threshold.

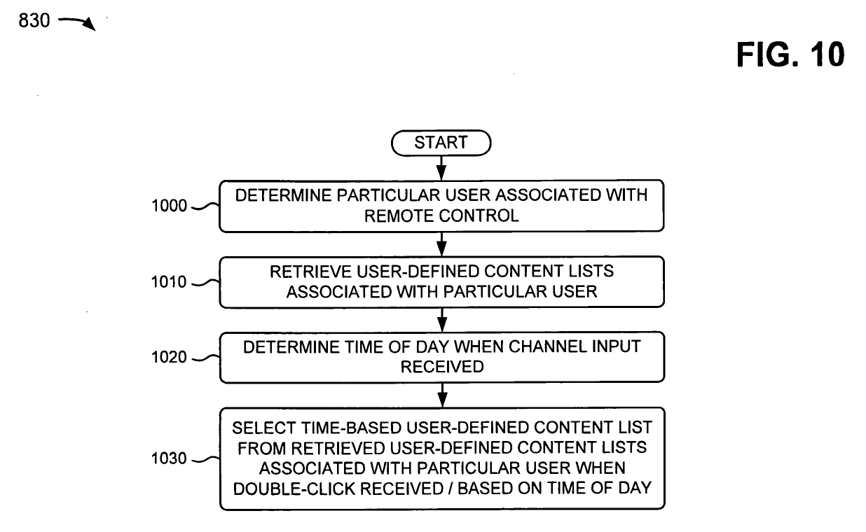

Process block 830 may include the process blocks depicted in FIG. 10. As shown in FIG. 10, process block 830 may include determining the particular user associated with the remote control (block 1000), and retrieving user-defined content lists associated with the particular user (block 1010). For example, in implementations described above in connection with FIGS. 5A-5C, a user may define different time periods of a day (e.g., morning, afternoon, and evening), and may define a different user-defined content list for each of the different time periods. In one example, a particular user may prefer news channels in the morning, talk show channels in the afternoon, and drama channels in the evening. In such an arrangement, STB 120 may determine a particular user associated with remote control 130 (e.g., via a password, a passcode, etc. provided to STB 120 by remote control 130). STB 120 may retrieve (e.g., from a database associated with STB 120 and/or content server 140) user-defined content lists associated with the particular user. In other implementations, a particular user may not need to be identified.

As further shown in FIG. 10, process block 830 may include determining a time of day when the channel input is received (block 1020), and selecting a time-based user-defined content list from the retrieved user-defined content lists, associated with the particular user, when a double-click is received and based on the time of day (block 1030). For example, in implementations described above in connection with FIGS. 5A-5C, STB 120 may determine a time of day when a double-click channel input is received from remote control 130. STB 120 may select a time-based user-defined content list (e.g., a news channels list in the morning, a talk show channels list in the afternoon, and a drama channels list in the evening) from the retrieved user-defined content lists when the double-click channel input is received and based on the determined time of day. In one example, if it is the afternoon when the double-click channel input is received, STB 120 may retrieve the news channels, talk show, and drama channels lists, may determine it is the afternoon, and may select the talk show channels list from the retrieved lists.

Systems and/or methods described herein may permit a user to select a channel of a user-defined content list via double-click channel input provided by a remote control associated with the user. In one implementation, for example, the systems and/or methods may receive a channel input from a remote control associated with a user, and may determine whether the channel input is a “double-click” channel input. The systems and/or methods may retrieve a user-defined content list when the channel input is determined to be a double-click, and may tune to a channel of the retrieved user-defined content list. The systems and/or methods may receive content associated with the tuned to channel, and may provide the received content for display to the user.

The foregoing description of implementations provides illustration and description, but is not intended to be exhaustive or to limit the invention to the precise form disclosed. Modifications and variations are possible in light of the above teachings or may be acquired from practice of the invention.

For example, while series of blocks have been described with regard to FIGS. 8-10, the order of the blocks may be modified in other implementations. Further, non-dependent blocks may be performed in parallel.

It will be apparent that exemplary aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Further, certain portions of the invention may be implemented as “logic” that performs one or more functions. This logic may include hardware, such as an application specific integrated circuit or a field programmable gate array, or a combination of hardware and software.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the present application should be construed as critical or essential to the invention unless explicitly described as such. Also, as used herein, the article “a” is intended to include one or more items. Where only one item is intended, the term “tone” or similar language is used. Further, the phrase “based on” is intended to mean “based, at least in part, on” unless explicitly stated otherwise.

What is claimed is:

1. A method implemented by a set-top box (STB), the method comprising:
receiving, by the set-top box, a channel input from a remote control associated with a user;
determining, by the set-top box, whether the channel input is a double-click channel input;
retrieving, by the set-top box, a user-defined content list when the channel input is determined to be a double-click channel input;
tuning, by the set-top box, to a channel associated with the retrieved user-defined content list;
receiving, by the set-top box, content associated with the tuned to channel; and
providing, by the set-top box, the received content for display to the user.

2. The method of claim 1, where the channel input comprises selection of a channel button of the remote control by the user.

3. The method of claim 1, where the user-defined content list is associated with the user.

4. The method of claim 1, where tuning to a channel comprises:
tuning to a first channel associated with the retrieved user-defined content list.

5. The method of claim 1, where the channel input includes a first channel input and a second channel input and the method further comprises:
receiving the first channel input from the remote control at a first time; and
receiving the second channel input from the remote control at a second time different than the first time.

6. The method of claim 5, further comprising:
determining a time period between the first time and the second time;
comparing the time period to a user-defined time threshold; and
determining that the first channel input and the second channel input are the double-click channel input when the time period is less than or equal to the user-defined threshold.

7. The method of claim 6, further comprising:
determining that the first channel input and the second channel input are a single-click channel input when the time period is greater than the user-defined threshold.

8. The method of claim 1, further comprising:
tuning, when the channel input is not determined to be a double-click channel input, to a channel that is higher or lower than a channel currently being viewed by the user.

9. The method of claim 1, where retrieving a user-defined content list comprises one or more of:
retrieving the user-defined content list from the set-top box; or
retrieving the user-defined content list from a content server communicating with the set-top box.

10. The method of claim 1, where the user-defined content list comprises one or more of:
a favorite television channels list,
a preferred television channels list,
a list of video on-demand (VOD),
a list of high definition video on-demand (HD-VOD),
a list of television channels defined by the user,
a program guide, or
a video-on-demand menu.

11. The method of claim 1, where retrieving a user-defined content list comprises:
determining the user associated with the remote control;
retrieving a plurality of user-defined content lists associated with the user;
determining a time of day when the channel input is received; and
selecting, based on the time of day, the user-defined content list from the plurality of user-defined content lists when the channel input is determined to be a double-click channel input.

12. The method of claim 11, where determining the user comprises one or more of:
determining the user based on a password provided by the user via the remote control; or
determining the user based on a passcode provided by the user via the remote control.

13. The method of claim 1, where providing the received content for display comprises:
providing the received content to a television, where the television displays the received content to the user.

14. A device, comprising:
a memory to store a plurality of instructions; and
a processor to execute instructions in the memory to:
receive a channel input from a remote control associated with a user,
determine whether the channel input is a double-click channel input,
retrieve a user-defined content list, associated with the user, when the channel input is determined to be a double-click channel input,
tune to a channel associated with the retrieved user-defined content list,
receive content associated with the tuned to channel, and
provide the received content to a television, where the television displays the received content to the user.

15. The device of claim 14, where the processor is further to execute instructions in the memory to:
tune to a first channel associated with the retrieved user-defined content list.

16. The device of claim 14, where the channel input includes a first channel input and a second channel input and the processor is further to execute instructions in the memory to:
receive the first channel input from the remote control at a first time, and
receive the second channel input from the remote control at a second time different than the first time.

17. The device of claim 16, where the processor is further to execute instructions in the memory to:
determine a time period between the first time and the second time,
compare the time period to a user-defined time threshold, and
determine that the first channel input and the second channel input are the double-click channel input when the time period is less than or equal to the user-defined threshold.

18. The device of claim 17, where the processor is further to execute instructions in the memory to:
determine that the first channel input and the second channel input are a single-click channel input when the time period is greater than the user-defined threshold.

19. The device of claim 14, where the processor is further to execute instructions in the memory to:
tune, when the channel input is not determined to be a double-click channel input, to a channel that is higher or lower than a channel currently being viewed by the user.

20. The device of claim 14, where the processor is further to execute instructions in the memory to one or more of:
retrieve the user-defined content list from a database associated with the device, or
retrieve the user-defined content list from a content server communicating with the device.

21. The device of claim 14, where the user-defined content list comprises one or more of:
a favorite television channels list,
a preferred television channels list,
a list of video on-demand (VOD),
a list of high definition video on-demand (HD-VOD),
a list of television channels defined by the user,
a program guide, or
a video-on-demand menu.

22. The device of claim 14, where the processor is further to execute instructions in the memory to:
determine the user associated with the remote control,
retrieve a plurality of user-defined content lists associated with the user,
determine a time of day when the channel input is received, and
select, based on the time of day, the user-defined content list from the plurality of user-defined content lists when the channel input is determined to be a double-click channel input.

23. The device of claim 22, where the processor is further to execute instructions in the memory to one of:
determine the user based on a password provided by the user via the remote control, or
determine the user based on a passcode provided by the user via the remote control.

24. The device of claim 14, where the device comprises a set-top box.

25. A system, comprising:
means for receiving a channel input from a remote control associated with a user;
means for determining whether the channel input is a double-click channel input;
means for retrieving a user-defined content list when the channel input is determined to be a double-click channel input;
means for tuning to a channel associated with the retrieved user-defined content list;
means for receiving content associated with the tuned to channel; and
means for providing the received content to a television, where the television displays the received content to the user.
